(19) United States
(12) Patent Application Publication
(10) Pub. No.: US 2025/0117616 A1
(43) Pub. Date: Apr. 10, 2025

(54) SECURE PRIVILEGED MAIL AUTHENTICATION AND TRANSMISSION SYSTEM

(71) Applicant: Ziauddin Rana, Owings Mills, MD (US)

(72) Inventor: Ziauddin Rana, Owings Mills, MD (US)

(21) Appl. No.: 18/906,293

(22) Filed: Oct. 4, 2024

Related U.S. Application Data
(60) Provisional application No. 63/542,444, filed on Oct. 4, 2023.

(51) Int. Cl. G06K 19/06; G06Q 50/26

(52) U.S. Cl. CPC G06K 19/06037; G06Q 50/26

(57) ABSTRACT

A system for screening and secure distribution of all correspondence to incarcerated individuals, including both personal mail as well as “privileged” inmate mail (legal mail and medical mail), that mitigates the threat of contraband. The system deploys a dashboard to each participating party, including a privileged sender dashboard that enables attorneys, public officials, and educators to pre-register and pre-authenticate themselves, and thereafter send privileged mail both online and through the U.S. postal service to incarcerated individuals. A remote prescreening application for institution staff facilitates validation and authentication, thereby mitigating contraband and impersonation.

### CROSS-REFERENCE TO RELATED APPLICATION(S)

The present application derives priority from U.S. Provisional Patent Application 63/542,444 filed 4 Oct. 2023.

### BACKGROUND OF THE INVENTION

### 1. Field of the Invention

The present invention relates generally to computer processes and, in particular, a computer process for screening and distribution of all correspondence to incarcerated individuals.

### 2. Description of the Background

Many prisons now rely on third party mail processors to screen physical mail. For every piece of postal mail received at the facility, processor staff must look up the inmate, determine whether the inmate is allowed to receive any mail, determine whether the inmate is allowed to receive mail from that particular sender, sort the mail for delivery based on inmate housing assignments, and then screen the mail for contraband, sexually explicit language or other unlawful content. However, screening rules vary from state to state and institution to institution. Consequently, different states, third party mail processors and correctional facilities must each take different approaches to screening for contraband. Such non-uniformity can frustrate family members. For example, a family member may send numerous photos only to have them all screened out due to one that is borderline. On the other hand, screening staff can sometimes make errors in judgment. In addition, in many state prison systems inmates are transferred frequently and families are not always notified of transfers until long after the move. Nevertheless, the mail delivery process is a daily activity, and it demands substantial processor resources to accomplish the task.

For example, U.S. Pat. No. 9,311,627 to Shipman, Jr. et al. issued Apr. 12, 2016 shows a mail processing and delivery system for use within a controlled-environment facility that converts hard copy mail to digital mail items, compares the sender/addressee to an electronic database to determine whether the inmate is allowed to receive the physical mail or not, and whether an electronic message service is available to the inmate. Based on the result the digital format mail item is either delivered electronically, printed for distribution, or not delivered.

Similarly, United States Patent Application 20160337360 by Logan shows a correctional postal mail contraband elimination system that scans inmate postal mail to an electronic format. The scanned mail may then be made available to the intended inmate and institution staff. Institution staff may also then access the associated information and tracking data.

Another solution is disclosed in U.S. Pat. No. 11,178,278 issued to the present inventor. The '278 patent discloses a platform to facilitate communications between families and friends and their incarcerated loved ones more securely, conveniently and affordably, and with full audit trail for accountability. Incoming mail is opened and scanned to cloud storage. Each involved party is provided a computer dashboard, and the various participant dashboards update a transaction record and provide a collaboration platform that automates key facets of the process, allowing correctional facility staff to fulfill their screening duties, and then deliver the screened mail to inmates. The platform allows families, friends and incarcerated loved ones to communicate more quickly, efficiently and inexpensively. This platform is in commercial use and has largely eliminated contraband smuggling through the regular personal family and friend's mail sent to inmates.

Although the foregoing solutions are adept at processing personal mail sent from family and friends to inmates, they are less adept at processing “privileged” mail sent from attorneys, public officials, educational organizations and the like. This is because correctional facilities as well as their third party mail processors must comply with applicable federal and state laws with respect to handling privileged inmate mail (typically defined as legal mail and medical mail). Such laws provide enhanced protection: privileged mail may only be opened and inspected to the extent necessary to determine whether it contains contraband. Consequently, many correctional facilities do not allow third party mail processors to process privileged mail, but rather process it themselves onsite. Unfortunately, it is easy to create bogus law office stationery and send drug-laced mail as legal mail to trick the officers and the system. Fraudsters know this and take advantage of it by impersonating attorneys or physicians. This is causing an increasing influx of dangerous contraband by in the form of bogus medical or legal mail. To date there is no practical barrier or process established to stop the ongoing contraband smuggling or impersonation. The threat is now occurring at an increasing rate in the entire correctional space.

What is needed is an operational process and system designed to mitigate the contraband and impersonation concerns when receiving, opening, and processing privileged mail.

### SUMMARY OF THE INVENTION

An object of the present invention is to provide an innovative system, method and computer program product for managing cross-platform communications with correctional inmates inclusive of both personal and privileged mail.

Another object is to provide a process and system designed to mitigate the contraband and impersonation concerns when receiving, opening, and processing privileged mail.

According to embodiments of the invention, the invention is a system and computerized process for screening and secure distribution of all correspondence to incarcerated individuals, including both personal mail as well as “privileged” inmate mail (legal mail and medical mail), that mitigates the threat of contraband from counterfeit privileged mail sent by legal, medical or other impersonators. The present system does this by providing a Software as a Service (SaaS) hosted by an application service provider (ASP) that deploys a dashboard to each participating party, including a privileged sender dashboard that enables attorneys, public officials, educators and other organizations to pre-register and pre-authenticate themselves, and thereafter send legitimate privileged mail both online and through the U.S. postal service to incarcerated individuals, and a remote prescreening application for institution staff. The privileged sender dashboard allows privileged-mail senders to choose whether to send via electronic mail or a hard copy mail piece through the U.S. postal service. If the latter, the system generates a unique Mail Origin Verification code (“MOVE Code”) comprising a 64-bit code. The MOVE Code is uniquely-generated for each mail piece, identifies the sender, receiver, correctional institution, and includes a user-configurable expiration (one-day, fifteen days, etc.). The system generates an image of the MOVE Code, the image including both an encrypted QR Code encoding the entire 64-bit MOVE Code plus an unencrypted fifteen-character string appearing beneath the QR Code which includes a 4-character facility identifier (“Prison Code”), a five-character inmate identifier, and a unique 4-to-6 character identifier assigned to that particular QR Code (“QR Code identifier”). The system then prompts the privileged mail sender to attach the MOVE Code image to the privileged mail piece, and to take a photo of the sender holding both an identification document (ID) as well as the mail piece with MOVE Code image attached. The system then uploads and stores the composite photo of the sender/ID/MOVE Code image. Upon receipt of the USPS-delivered privileged mail piece, the cloud-based identity verification application allows institution staff to visually match the unencrypted Prison Code, inmate identifier, and QR Code identifier, as well as scan the MOVE Code image to display the information associated with MOVE Code for validation and authentication. The system mitigates three distinct problems:
1. Contraband—Hard-To-Detect Dangerous Chemicals/Narcotics.
2. Impersonation—Potentially Contaminated/Bogus Legal or Medical Mail.
3. Bulk Mail Management—Reduces clutter and unnecessary time wastage by using the streamlined large-scale educational document intake and processing solution.
   The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which.

FIG. 1 is a block diagram illustrating a distributed network system and architecture suitable for implementing the present system in accordance with embodiments of the invention.

FIG. 2 is screen print of the facility staff 130 portal landing page.

FIG. 3 is a screen print of the digital privileged mail processing system, sender verification controls and sender credibility assessment system.

FIG. 4 is a screen print of the Manage Sender page with Sender Approval Settings to approve sender per facility, and to customize the identification document requirement for the sender's credibility assessment and verification.

FIG. 5 is screen print of the privileged sender dashboard for attorneys, public officials, educational organizations and the like.

FIG. 6 is a screenshot of the new privileged document order creation page.

FIG. 7 is a screenshot of the privileged mail order ready to submit screen.

FIG. 8 is a screenshot of the MOVE Code generation and retrieval options screen.

FIG. 9 is a sequential block diagram of the present process.

FIG. 10 is a screen print of the correctional facility dashboard for processing privileged mail.

FIG. 11 is a screen print of the postal mail delivery roster document that is used to escort corresponding inmate to a centralized legal mail processing room to process mail in their presence.

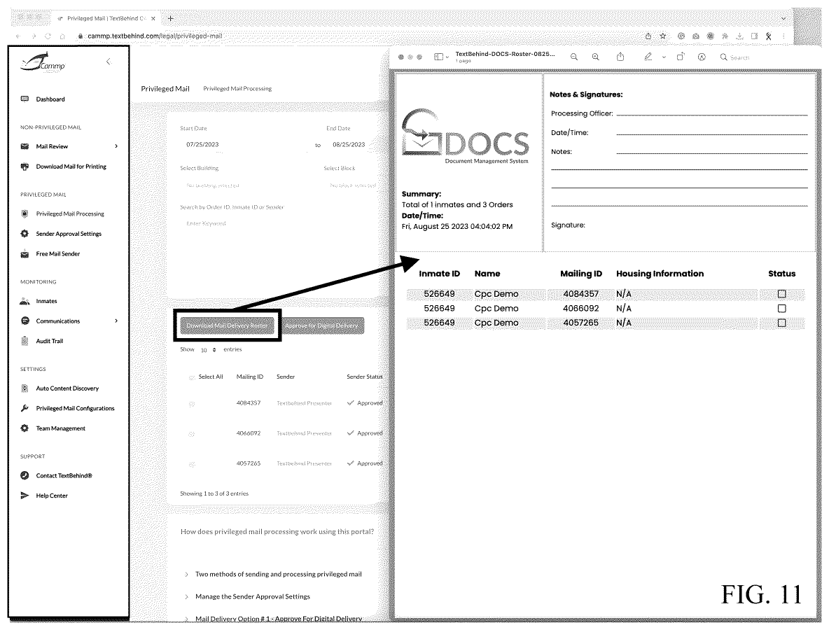

FIG. 12 is a screen print of the processing section of the processing wizard.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is a system and computerized process for screening and secure distribution of all correspondence to incarcerated individuals, including both personal mail as well as “privileged” inmate mail.

For purposes of description “privileged mail” is herein defined as incoming mail to a correctional inmate that has any special right, advantage, or immunity from screening granted or available to it by law or policy. Privileged mail includes legal mail, medical mail, and in some states educational mail.

The present system accomplishes its goal by providing a Software as a Service (SaaS) hosted by an application service provider (ASP) that deploys a dashboard to each participating party, including a privileged sender dashboard that enables attorneys, public officials, educators and other organizations to pre-register and pre-authenticate themselves, and thereafter send legitimate privileged mail both online and through the U.S. postal service to incarcerated individuals, and a remote prescreening application for institution staff. The privileged mail sender dashboard allows privileged mail senders to choose whether to send via electronic mail or a hard copy mail piece through the U.S. postal service. The system described herein mitigates three distinct problems:
1. Contraband—Hard-To-Detect Dangerous Chemicals/Narcotics.
2. Impersonation—Potentially Contaminated/Bogus Legal or Medical Mail.
3. Bulk Mail Management—Reduces clutter and unnecessary time wastage by using the streamlined large-scale educational document intake and processing solution.

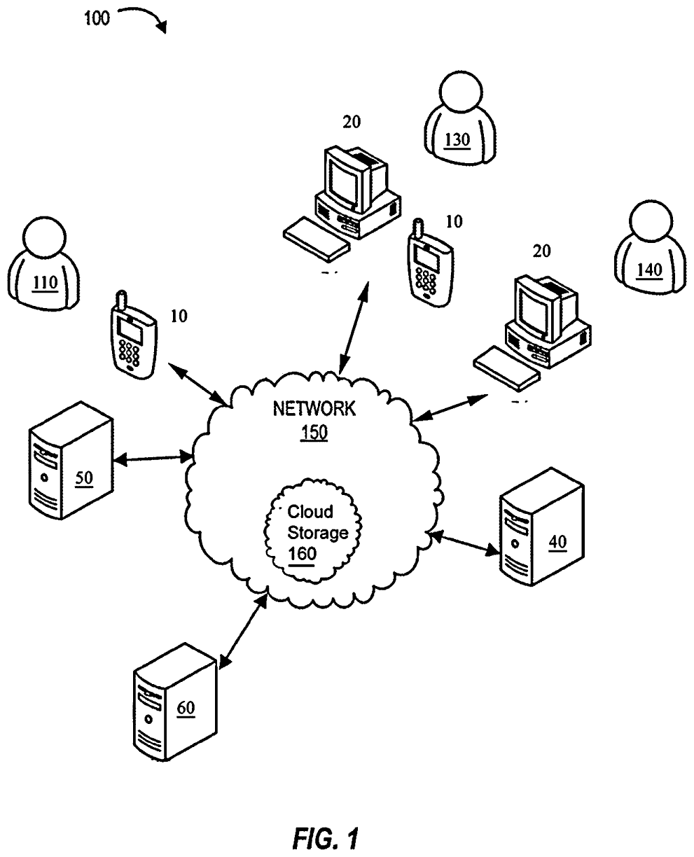

As illustrated in FIG. 1, system 100 participants include an incarcerated inmate 110, one or more legal or medical, practitioners, public officials, educators or educational organizations, or any other privileged mail providers 140, correctional facility staff 130, and application service provider (ASP) 50. Inmate 110, facility staff 130, and privileged mail providers 140 may each access the system 100 via a mobile device 10 and/or a personal computing device 20. The mobile devices 10 and the personal computing devices 20 are configured to communicate over a network 150 with a correctional facility server 40, and back-end ASP system 50. The ASP 50 provides Software as a Service (SaaS) via communications network 150. ASP system 50 is configured to communicate over network 150 with a remote screening station 60. As seen in FIG. 1 a cloud-based repository 160 is part of the network 150. Cloud-based repository 160 provides a virtual storage solution between ASP 50 and remote screening station 60 as will be described.

As used herein, a “mobile device” 10 is any smart mobile communication device capable of executing third-party software, such as a cellular telecommunications device (i.e., a cell phone or mobile phone), personal digital assistant (PDA), a mobile Internet accessing device, or other mobile device.

The personal computing device 20 may be any conventional personal computer that employs a processor and memory and can perform computing and data communication functions, such as a personal computer, tablet or other known device.

The network 150 may include a local area network (LAN), a wide area network (WAN), and/or a global area network (GAN). The network 150 may provide for wired, wireless, or a combination of wired and wireless communication between devices in the network. In one embodiment, the network 150 includes the Internet. In one embodiment, the network 150 includes a wireless telephone network.

The mobile devices 10 and personal computing devices 20 are configured with application software providing a user-interface dashboard specific to each party, including a general inmate dashboard, a privileged sender dashboard that enables attorneys, public officials, educators, and other organizations to pre-register and pre-authenticate themselves, and thereafter send legitimate privileged mail, a family/friend dashboard, Department of Corrections (DOCs) facility staff dashboard, and ASP dashboard. The respective dashboards facilitate curated communication as will be described. The dashboards for mobile devices 10 may be mobile applications, and for computers 20 may be implemented as standalone software programs or a server-side program resident on ASP server 50 with a thin-client front end on computers 20.

All the dashboards for mobile devices 10 and computers 20 intercommunicate via network 150 and thereby provide a collaboration platform. The cloud-based repository 160 provides an economical virtual storage solution between ASP 50 and remote screening station 60 as described below.

Each individual user is assigned login credentials by ASP 50 and in order to access the respective user account(s) must authenticate with the ASP 50. For example, logging in generally requires that the user 110-140 authenticate his/her identity using a user name, a passcode, a cookie, a biometric identifier, a private key, a token, and/or another authentication mechanism that is provided by the user 110-140 via their mobile device 10 or computer 20. In accordance with the present invention privileged mail senders 140 such as attorneys, public officials, and educational organizations must initially pre-register, add their contact information, upload identification documents, and secure pre-approval from facility staff 130. Facility staff 130 manage each registered privileged-sender's “Approval Settings” and may customize the identification documents requirement for each sender's verification. When a privileged sender has pre-registered, submitted the identification documents requirement for verification and otherwise fulfilled all approval settings, the system facilitates their sending of a physical mail piece to an inmate. Should the sender choose to do this, the system issues a secure and conveniently downloadable unique code (“MOVE Code”) comprising a 64 character alphanumeric code that uniquely associates that particular mail piece with that particular sender account (inclusive of contact information, ID documents, custom permission set, and MOVE Code persistence parameters (e.g., a user-configurable expiration: one-day, fifteen days, etc.). All MOVE Codes are unique and single-use, such that each mail piece requires a unique new code. However, persistence timeframes such as a day, week, or a month are configurable.

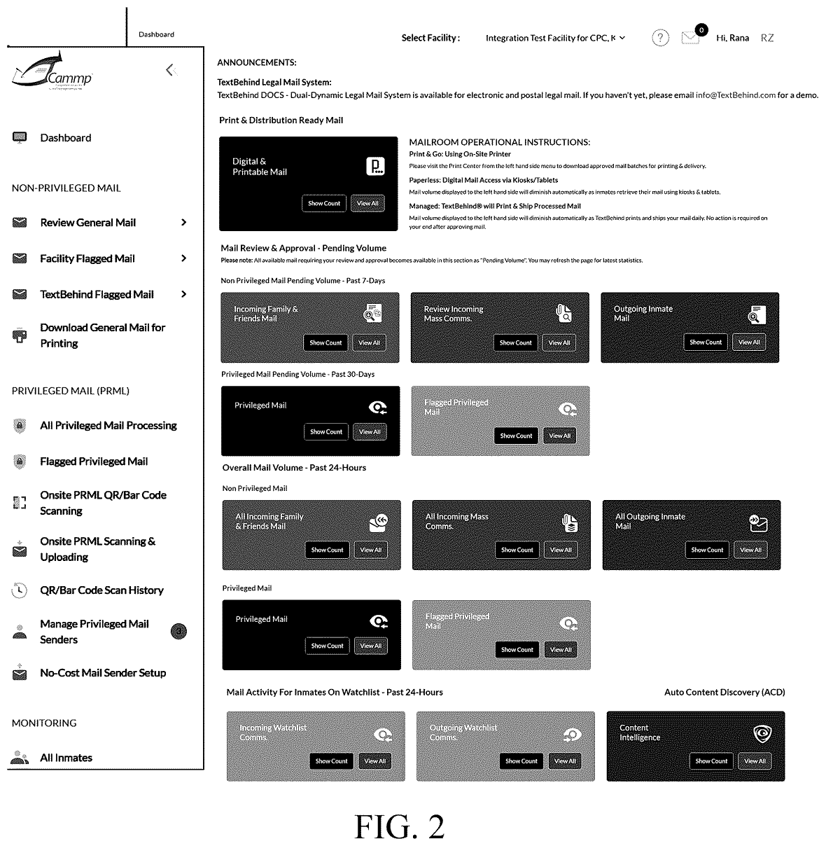

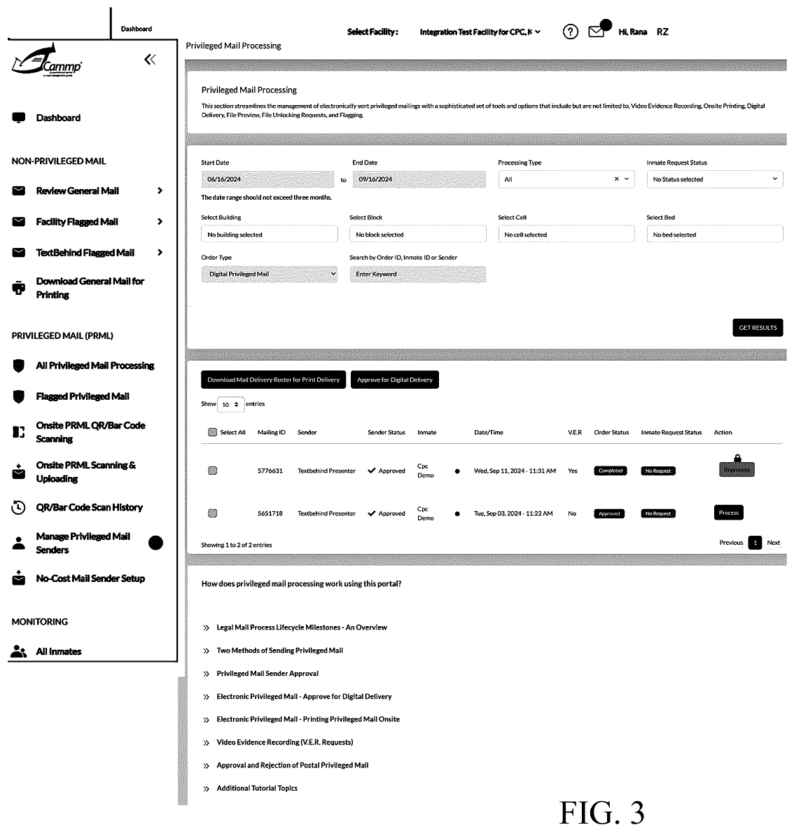

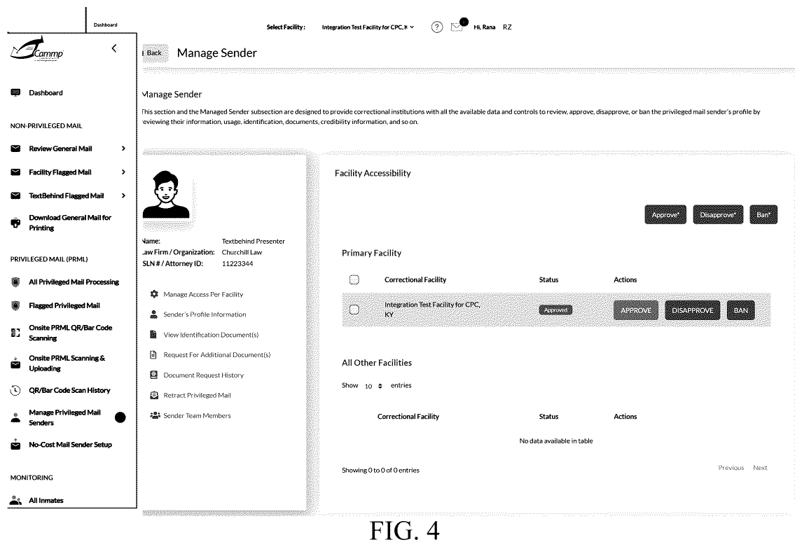

The system generates an image of the MOVE Code comprising both an encrypted QR Code encoding the entire 64-bit MOVE Code plus an unencrypted fifteen-character string appearing beneath the QR Code which includes a 4-character facility identifier (“Prison Code”), a five-character inmate identifier, and a unique 4-to-6 character identifier assigned to that particular QR Code (“QR Code identifier”). The system then prompts the privileged mail sender to attach the MOVE Code image to the privileged mail piece, as well as upload an image of the sender displaying an ID and the mail piece with MOVE Code image attached. The privileged sender 140 can then send to the desired inmate conveniently and securely using the flexible MOVE Code, which staff 130 then scans, decrypts and verifies as a mechanism to mitigate impersonation threats related to the privileged mail senders. The correctional institution staff 130 can customize the identification document requirements and the MOVE Code encryption parameters for the sender 140 credibility assessment and verification. FIG. 2 is screen print of the facility staff 130 portal landing page, notably announcing that the system can now be used to process privileged mail sent electronically or through the postal service. The facility staff 130 landing page provides a left-side dashboard to guide staff in their processing of mail, including categorical options for 1) Non-Privileged Mail (Review General Mail; Review Facility Flagged Mail; Review TextBehind Flagged Mail; and Download General Mail For Printing): 2) Privileged Mail (All Privileged Mail Processing; Flagged Privileged Mail; Onsite PRML/QR Bar Code Scanning; Onsite PRML Scanning & Uploading; QR/Bar Code Scan History; Manage Privileged Mail Senders; No-Cost Mail Sender Setup); and 3) Monitoring (All Inmates). Facility staff 130 may click on the left-appearing Privileged Mail—Manage Privileged Mail Senders button to customize the identification documents requirement for the sender's credibility assessment and verification. Doing so yields the screen of FIG. 3, which presents a dashboard that streamlines the management of privileged mailings. At top center staff 130 may search for authorized senders by a range of “Start Date” to “End Date”, “Processing Type”, “Inmate Request Status”, Facility Details (Building, Block, Cell, and Bed), “Order Type” (Digital Privileged Mail, Hard Copy Privileged Mail, etc.) or Keyword Search (Including Sender ID, Sender Name, Law Firm, etc.). Matching search results and current Sender Approval Status are shown beneath (center panel), and each identified Sender is displayed as a link that allows staff to edit parameters or customize the identification document requirements for the sender's credibility assessment and verification. Clicking the “Sender” link yields the Manage Sender screen of FIG. 4 with Sender Approval Settings to approve senders per correctional facility, and which facilitates customization of the identification document(s) required for each sender's credibility assessment and verification. The Manage Sender page provides all post-registered details on the selected privileged sender 140, e.g., “TextBehind Presenter” including affiliation “Churchill Law”, SLN #/Attorney ID, Bar Membership, Website, etc. The “Manage Access Per Facility” control allows staff to designate which facilities the sender 140 is approved to send to. The “View Identification Document(s)” allows staff 130 to view the documents used for authentication. The “Request For Additional Document(s)” control allows staff 130 to specify additional documents needed for authentication. The “Document Request History” shows an audit trail of document requests. The “Retract Privileged Mail” control allows staff 130 to retract an approval. The “Sender Team Members” control allows staff 130 to view individual data for firm attorneys. Privileged senders 140 pre-register and provide the foregoing information and upload authentication documents, and a third party application service provider completes a formal review of the privileged sender 140 registration information and prerequisite documents before sender 140 is allowed to do anything else. Then any privileged mail sender 140 who desires to send privileged mail by the U.S. postal service is required to print a unique QR Code label, attach it to the privileged mail envelope, and take a picture of themself displaying an identification ID document and their “ready to ship” legal mail envelope with the unique Code attached, and upload the photo to their dashboard. The label includes the encrypted QR Code representing the entire 64-bit MOVE Code (inclusive of contact information, ID document, custom permission set, and QR Code persistence parameters (e.g., a user-configurable expiration: single-use, one-day, fifteen days, etc.), plus an unencrypted fifteen-character string appearing beneath the QR Code which includes a 4-character facility identifier (“Prison Code”), a five-character inmate identifier, and a unique 4-to-6 character identifier assigned to that particular QR Code (“QR Code identifier”). The non-encrypted portion allows staff 130 at the facility to visually match the code appearing on the legal mail envelope received from USPS with the scanned image on the envelope. This adds a valuable additional security layer to entirely block impersonators. The encrypted portion when scanned provides the information associated with MOVE Code for validation and authentication.

The Retract Privileged Mail function can be used if facility staff 130 determines that a particular pre-authorized sender 140 is actually fake. If so, staff 130 can not only cancel the approval status of that sender 140 profile but also “Retract” past communication. The communication history of that sender 140 with any inmate will disappear.

Given the foregoing, privileged senders 140 may choose to send and receive their privileged mail either electronically or by USPS, and the Manage Privileged Mail Senders approval settings provide a comprehensive set of features for the correctional institution to not only assess and manage the sender 140 credibility in the system but to do it uniquely for each specific institution as well as system-wide. This effectively creates a restrictive barrier for impersonators to prevent fraud.

When a sender 140 seeks to send privileged mail electronically the sender must be pre-registered, and pre-authenticated, and must specify additional parameters such as the facility and inmate recipient. Assuming staff 130, ASP 50, or a third-party service vendor has approved their profile the sender 140 may then compose a privileged message via their dashboard. ASP 50 provides a secure electronic messaging platform between all parties 110-140. Thus, correctional facility staff 130 may invoke their dashboard on computer 20 or mobile device 10 and either print and deliver the message in hardcopy, or provide the inmate recipient with a tablet or kiosk to view it. The sender 140 pre-registration and pre-authentication is automatically verified by ASP 50 to prevent mail duplication, circumvention, and misuse.

Alternatively, when a sender 140 seeks to send privileged hardcopy mail via the USPS system the sender must be pre-registered, and pre-authenticated and must specify additional parameters such as the facility and inmate recipient. Again, assuming staff 130, ASP 50, or a third-party service vendor has Approved their profile, ASP 50 dynamically generates a Mail Origin Verification QR Code for attachment to their hardcopy letter (described below). If Evidence of Mail Origin Verification is enabled, the privileged mail sender 140 is required to take a picture of themselves holding both 1) the hardcopy mail piece bearing the QR Code, and 2) an identification (ID) such as a license. The photo must at least include the following:
a full facial view of the sender 140;
the photo ID that was used to register (passport or driver's license); and
   the “ready to ship” legal mail envelope with QR Code attached (per below).
hardcopy mail piece bearing the QR Code.
The photo image is uploaded it to their dashboard and saved as a JPEG or JPG file type. In this case, the QR Code shown on the envelope includes both the 64 characternon-encrypted alpha-numeric code that is human-readable plus scannable encrypted code. The hardcopy letter is mailed to the facility, but facility staff 130 may not open without reason to believe that it contains contraband, and even then the mail must be opened in the presence of the inmate. If Evidence of Mail Origin Verification was enabled staff 130 at the facility can visually match the code appearing on the legal mail envelope received from USPS with the scanned image on their dashboard. If not, upon receipt, facility staff 130 scan the QR Code which is automatically verified and cleared by ASP 50. Given clearance, staff 130 may safely open the privileged mail in the presence of the inmate recipient and deliver the original. The use of the QR code effectively prevents mail duplication, circumvention, and misuse, and the added protection of the Evidence of Mail Origin Verification adds a valuable additional security layer to entirely block impersonators.

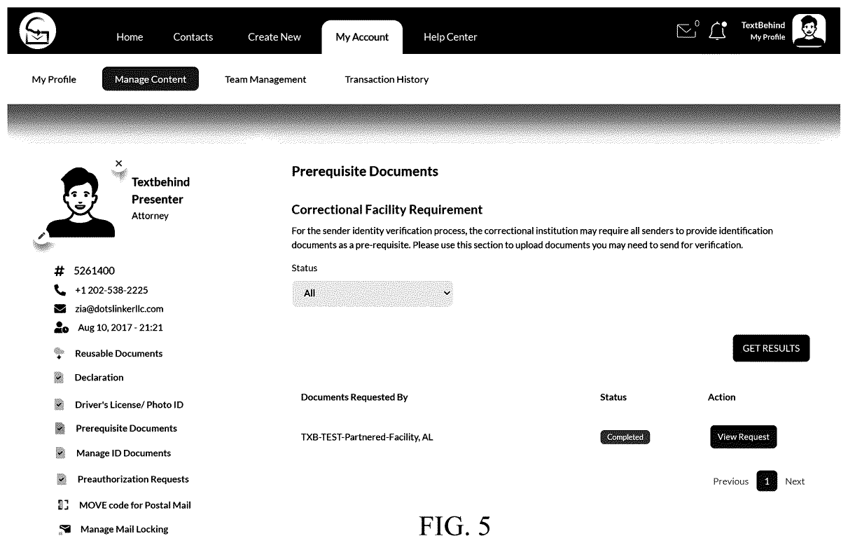

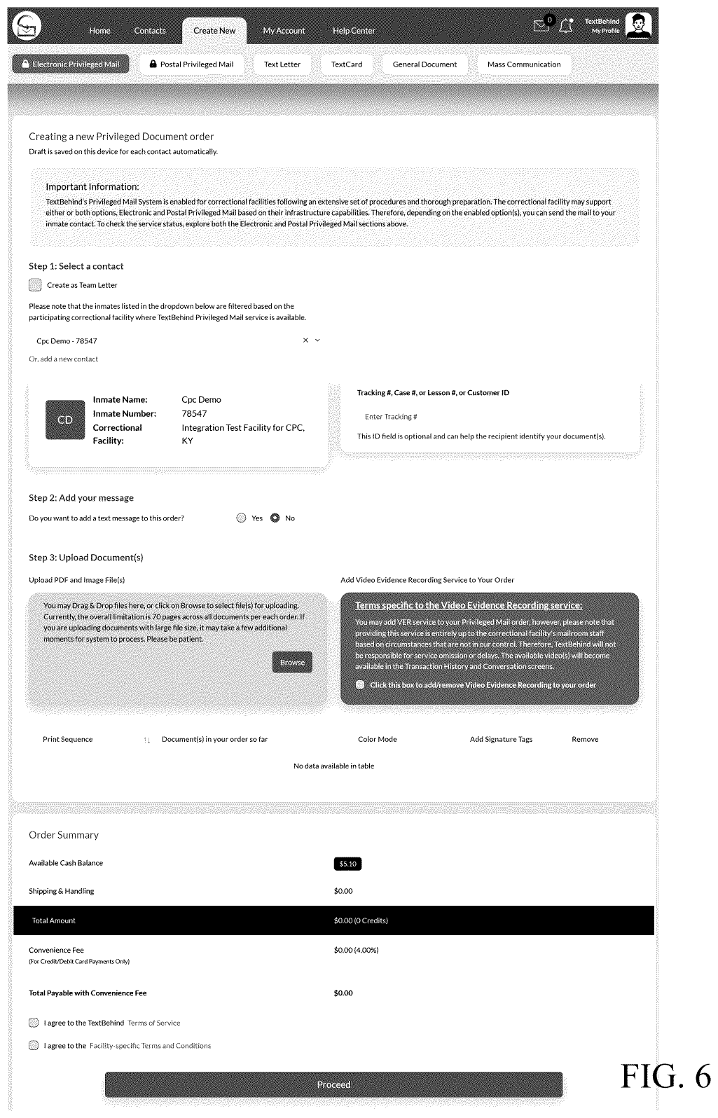

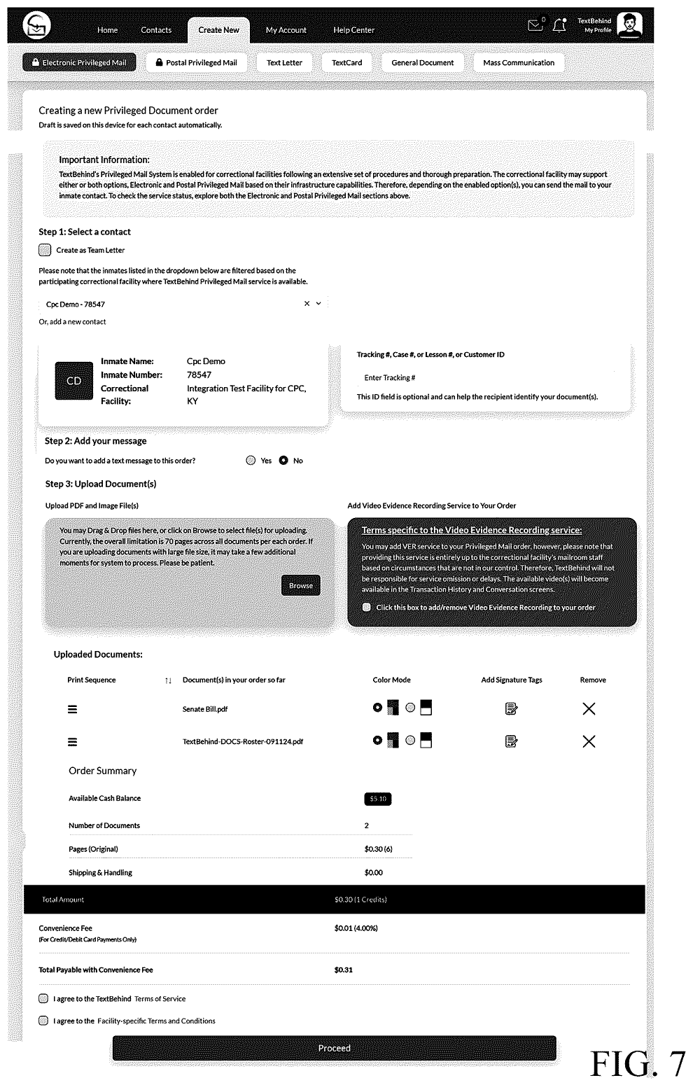

FIG. 5 is screen print of the privileged sender dashboard that for attorneys, public officials, and organizations to register, add contacts, upload identification documents, and send them to the desired inmate recipients. The sender 140 authentication dashboard requires initial registration of an account online to provide profile information and authentication documents before sending privileged mail. When the sender 140 is pre-registered and has uploaded designated authentication documents, they can manage their authentication document status as shown. The leftmost panel provides links to upload authentication documents including “Reusable Documents”, an authentication “Declaration”, Driver's License/Photo ID, and other Prerequisite Documents, as well as to “Manage ID Documents”, view/edit “Preauthorization Request”, or view the assigned Code for sending Postal Mail. The central panel allows searching for document requests from correctional facility staff 130 with a given Start Date, End Date and/or Status. A filtered listing of documents appears below including Completion Status and, if appropriate, a View Request button. When the sender 140 is pre-registered and has uploaded designated authentication documents and they are fully approved, the sender 140 may send a privileged letter to an inmate electronically by inputting the facility and inmate recipient. Using the “Create New” index tab at the top of FIG. 5, they may create a new privileged document order as shown in FIG. 6. The sender 140 selects a contact, and tracking number (Step 1), optionally adds a text message (Step 2) and may upload the privileged document(s) that they wish to send (Step 3). When the privileged mail order is ready to submit, the details are shown in FIG. 7 and the sender 140 clicks Proceed. The privileged letter is sent electronically for viewing by inmate 110, or for printing and delivery to inmate 110 by staff 130. Note that whether the privileged mail is sent electronically for digital delivery on inmate tablets/kiosks or reprinted onsite, the sender 140 may request video evidence recording of the delivery process to ensure proper delivery.

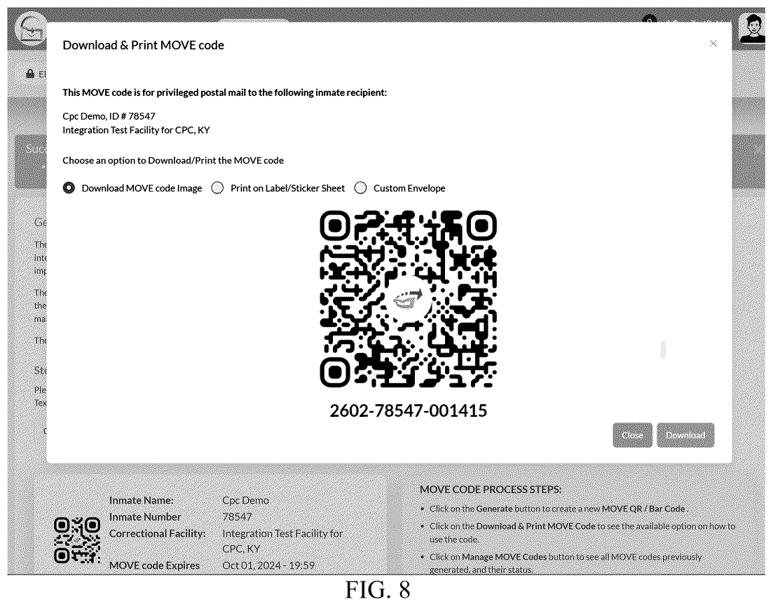

Alternatively, the sender 140 may send a privileged hardcopy letter to an inmate by the U.S. postal service electronically by inputting the facility and inmate recipient. In this case, as shown in FIG. 8, the sender 140 may choose to generate a Mail Origin Verification Code (“MOVE CODE) for Postal Mail” at left. The sender 140 dashboard automatically generates a downloadable/printable label bearing a composite image of the unencrypted MOVE Code plus encrypted QR Code 142 for attachment to the outside-left-bottom of the privileged mail envelope. The QR Code 142 includes the key-encrypted MOVE Code unreadable to anyone outside the present system. The only way to access the encrypted information is through a decryption key provided by the ASP 120. There are various suitable codes such as standard QR Code™, Micro QR code, PDF417, and data matrix. The encrypted information associated with the QR Code includes the following:
1) Complete profile data and pre-verification data either produced by a 3rd party automated system or ASP 50 staff.
2) List of documents uploaded in response to the prerequisite documents.
3) Encrypted URLs to all uploaded ID document(s).
4) Intelligent recommendation to tell the officer which action to take on each mail envelope based on system assessment.

In addition, if Evidence of Mail Origin Verification is enabled the QR Code label will also include the non-encrypted alphanumeric code so that staff 130 at the correctional facility can visually match the alpha-code appearing on the legal mail envelope received from USPS with the scanned image on their dashboard.

Importantly, in addition to the ability to control “Sender Approval Settings”, facility staff 130 may also customize the MOVE Code security parameters associated with each generated code. Thus, as seen in FIG. 8 these parameters are displayed including validity timeframe (1 day, 1 week, 1 month, etc.); facility, and inmate 110. Staff 130 may determine five levels of MOVE Code customization:
1. Timeframe: Select if a QR Code should be valid for a particular timeframe (1 day, 1 week, 1 month, etc.);
2. Facility: Associate the QR Code to one or multiple correctional facilities under your management;
3. Party: Make it restricted to a specific attorney and an inmate; and
4. Usage: Require the sender to get a new QR Code for each new privileged mail envelope (one-time use).
5. Recursion: Defines how many QR Codes may be active at the same time. This condition is being built to mitigate certain real-life potential misuse of the codes already issued by the system to a user.

The customizable QR Code approach provides a far more sophisticated mechanism for processing USPS mail and dramatically reduces, if not eliminates contraband and impersonation threats associated with fake legal mail.

Given the foregoing mail senders 140 may send privileged communications to inmates utilizing either one or both methods for privileged mail management: (1) privileged mail is sent electronically for either digital delivery on inmate tablets/kiosks or reprinted onsite in inmate's presence with video evidence recording; and/or (2) privileged mail (with QR Code) is sent through the U.S. Postal Service.

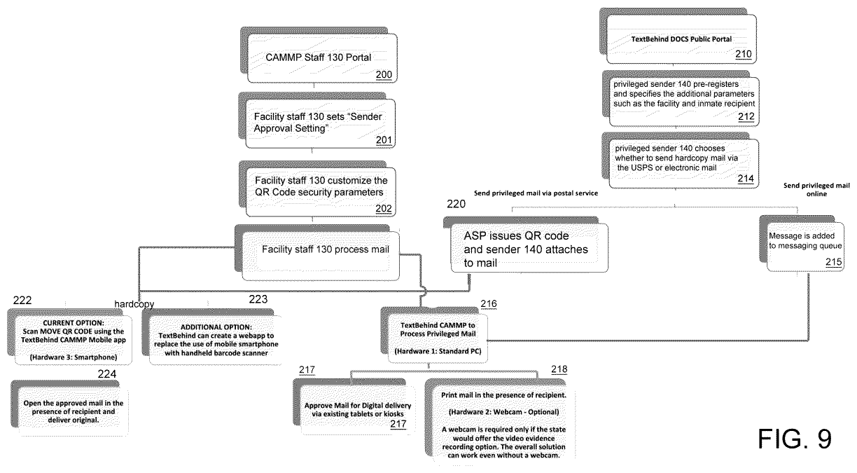

FIG. 9 is a sequential block diagram of the present process, which begins at step 200 with facility staff 130 logging into their staff dashboard and at step 210 with a privileged mail sender 140 logging into their public dashboard.

At step 201 facility staff 130 customize their “Sender Approval Settings” and specify the identification document requirements for the sender's credibility assessment and verification.

At step 202 staff 130 customize the QR Code security parameters: QR Code validity timeframe (1 day, 1 week, 1 month, etc.); facility validity (one or more correctional facilities); sender 140 (a specific attorney and/or inmate); and recursion parameters.

Meanwhile, at step 212 the privileged sender 140 pre-registers and specifies the additional parameters such as the facility and inmate recipient.

At step 214 the privileged sender 140 chooses whether to send hardcopy mail via the USPS or electronic mail.

If the privileged sender 140 chooses to send electronic mail, then at step 215 the ASP 50 provides a secure electronic messaging platform and the electronic message is added to a secure messaging queue. Flow branches left as shown. At step 216 correctional facility staff 130 may either print and deliver the message in hardcopy at step 218, or provide the inmate recipient with a tablet or kiosk to view it at step 217.

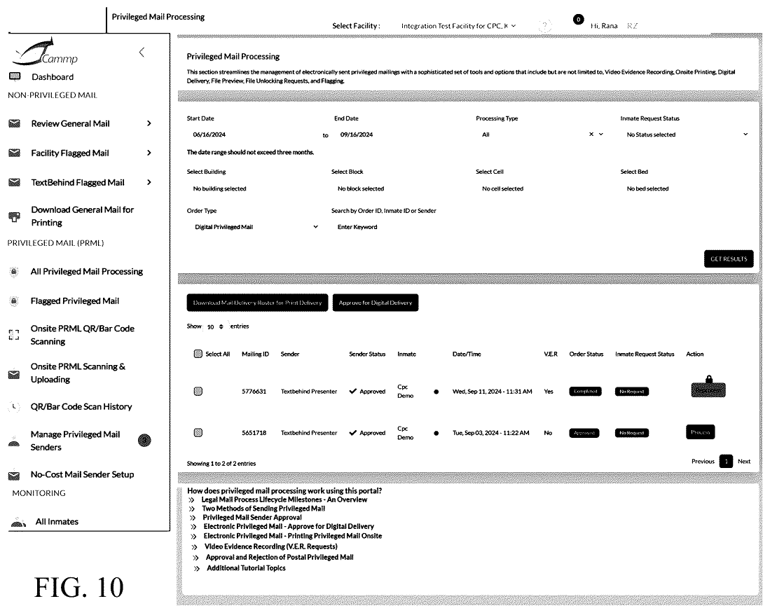

FIG. 10 is a screen print of the correctional facility dashboard for processing privileged mail, both electronic/digital and hard copy USPS. A filter selection appears across the top of the screen allowing the user to filter the listing of available pre-production PDFs by correctional facility, start date, end date, processing type (e.g., sender-requested video evidence recording or not), inmate request status, or by inmate name, building #, block #, cell or bed #. This filtering capability is important because it allows the corrections staff to process messages in batches that are defined by the manner in which the correspondence will be delivered. Thus, for example, if the correctional facility staff is responsible for delivering all of building #10 correspondence to a kiosk located therein he/she can filter the relevant mail accordingly. Similarly, if a user is responsible for delivering correspondence via tablet to be shared only between inmates in block #22 he/she can filter only the relevant correspondence accordingly. The filtered or unfiltered listing is shown below.

If the privileged sender 140 chooses to send hardcopy mail via the USPS, then at step 220 the sender dynamically generates and downloads a Mail Origin Verification QR Code, attaches it to their envelope and sends it. Flow branches left and at step 222, upon receiving USPS mail at the institution, mailroom staff 130 use their dashboard via a mobile device 10 at step 222 (smart phone-enabled App with scanning capability using integrated camera) and/or a personal computing device 20 at step 223 (and attached barcode scanner or webcam), and they scan the flexible QR Code to assess the credibility of the sender before approving the privileged mail. Once cleared and approved at step 224 facility staff 130 hand the hardcopy mail over to the inmate recipient. If the sender is not on the Approved sender list or has not pre-registered or pre-authenticated themselves the staff dashboard flags an alarm. Staff also has the option to request additional identification documents if the existing profile data is deemed insufficient to add the attorney to the Approved Senders List.

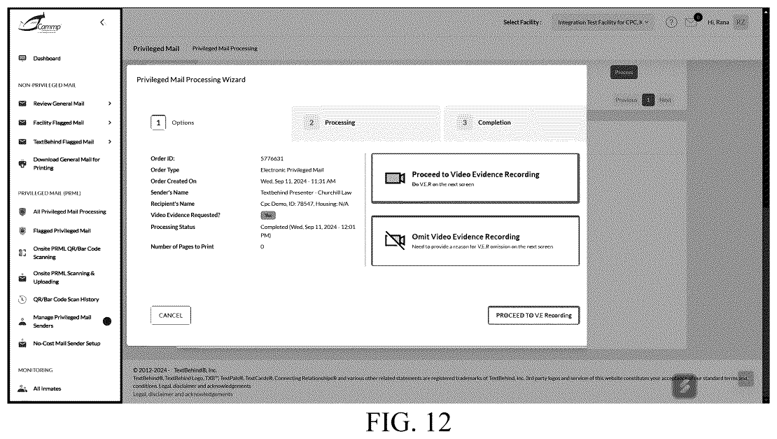

FIG. 12 is a screen print of the processing section of the processing wizard, which begins by displaying a choice of options: “Proceed To Video Evidence Recording (VER)” (in case the sender 140 requested video evidence recording) or not. This allows the staff 130 user the option of proceeding to video evidence recording or not. If they so choose then the system records and preserves a video from the local camera of facility staff 130 in their performance of step 218 (print and deliver hardcopy); providing the inmate recipient with a tablet or kiosk to view it at step 217, and/or handing the hardcopy mail over to the inmate recipient at step 224. If they choose not to video-record despite the sender's request then the system requires a reason. As indicated above our laws provide enhanced protection for privileged mail: it may only be opened and inspected to the extent necessary to determine whether it contains contraband. A unique feature of the present invention is an automatic file locking mechanism to mitigate any potential improper access by the correctional facility staff 130. The file locking mechanism is invoked when privileged mail is sent electronically. The electronic mail is processed once by ASP 50, and is immediately locked for access by the correctional office staff 130. However, electronic mail remains unlocked for viewing by the receiving inmate for access via a tablet or kiosk, Should staff 130 want to access the mail piece to reprint or otherwise, they must send an unlock request to the privileged mail sender 140 and provide an explanation. The privileged mail sender 140 will receive an email/text. If satisfied, the file can be unlocked for a specified amount of time or rejected. After such time-lapse, the file is locked again. The privileged mail sender 140 can also lock the file for the inmate. If so, the file will become inaccessible on the tablet.

No matter what form of correspondence all above-described dashboards capture their entire transaction log and compile an audit trail of redactions, deletions, distribution, etc., and transmit the audit log to ASP 50 for later inspection. When needed this protects or implicates the correctional facility staff against claims of selective treatment. The audit trails are transmitted back to ASP 50, consolidated and used to calculate metrics for viewing by the correctional facilities. Each audit trail comprises a record of action taken date, and associated USER. For each action, the system also provides a URL link to the screen where each change was made and its result. The audit logs are consolidated by ASP 50 by associating each audit log with the associated USER, ordering by Date, and sequencing by actions taken.

It should now be apparent that the above-described system, method and computer program product facilitates screening and secure distribution of all correspondence to incarcerated individuals, including both personal mail as well as “privileged” inmate mail (legal mail and medical mail), while mitigating the threat of contraband, and counterfeit privileged mail sent by legal, medical or other impersonators. The system also improves bulk mail management, reducing clutter and wasted time using streamlined large-scale educational document intake and processing solutions.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

I claim:

1. A system for screening and secure distribution of privileged correspondence to incarcerated individuals, comprising:
a server network hosted by an application service provider (ASP) comprising at least one server computer and a secure database management system including a master database containing an inmate record of inmate identification data and inmate location data, and a privileged mail sender record of privileged mail sender identification data and authentication documents; and
a plurality of client applications running locally on remote client computing devices and configured to communicate with said ASP server network, said client applications at least including,
a privileged sender dashboard that enables privileged senders including attorneys, public officials, and educators to pre-register and pre-authenticate themselves by uploading authentication documents, and thereafter send privileged mail both online and through the U.S. postal service to incarcerated individuals, whereby selecting to send a privileged mail piece through the U.S. postal service generates a QR code and prompts said privileged mail sender to attach said QR code to said privileged mail piece and upload an image of said mail piece with QR Code attached;
a remote prescreening application running on a remote client computing device and comprising software instructions configured to scan the QR Code attached to the mail piece, and display the uploaded image of said mail piece with QR Code attached for comparison and validation of said USPS-delivered mail piece with QR Code attached.

2. The system for screening and secure distribution of privileged correspondence according to claim 1, wherein the remote client computing device comprises a desktop computer, and the remote prescreening application running on said desktop computer comprises software instructions configured to scan the QR Code attached to the mail piece using an attached bar code scanner.

3. The system for screening and secure distribution of privileged correspondence according to claim 1, wherein the remote client computing device comprises a smart phone, and the remote prescreening application running on said smart phone comprises software instructions configured to scan the QR Code attached to the mail piece using an integrated camera.

4. A system for screening and secure distribution of privileged correspondence to incarcerated individuals, comprising:
a server network hosted by an application service provider (ASP) comprising at least one server computer hosting a secure database management system including a master database containing an inmate record of inmate identification data and inmate location data, and a privileged mail sender record of privileged mail sender identification data and authentication documents; and
a first client computing device in communication with said ASP server network and running a client application presenting a privileged sender dashboard configured to allow privileged senders including attorneys, public officials, and educators to pre-register and pre-authenticate themselves by uploading authentication documents.

5. The system for screening and secure distribution of privileged correspondence according to claim 4, wherein the privileged sender dashboard allows privileged-mail senders to choose whether to send via electronic mail or a hard copy mail piece through the U.S. postal service.

6. The system for screening and secure distribution of privileged correspondence according to claim 5, wherein upon choosing to send a hard copy mail piece through the U.S. postal service the system generates a QR code and prompts the privileged mail sender to attach the QR code to the privileged mail piece.

7. The system for screening and secure distribution of privileged correspondence according to claim 6, wherein the system prompts the privileged mail sender to upload an image of the mail piece with QR Code attached.

8. The system for screening and secure distribution of privileged correspondence according to claim 6, further comprising a second client computing device in communication with said ASP server network and running a client application presenting a remote prescreening application configured to scan the QR Code attached to the mail piece, and display the uploaded image of said mail piece with QR Code attached for comparison and validation.

9. The system for screening and secure distribution of privileged correspondence according to claim 6, wherein said QR Code comprises a multi-digit non-encrypted alpha-numeric code that is human-readable.

10. The system for screening and secure distribution of privileged correspondence according to claim 6, wherein said QR Code includes encrypted information includes at least privileged-sender profile data, a list of authentication documents uploaded by said privileged sender, and a link to access said authentication documents.

11. The system for screening and secure distribution of privileged correspondence according to claim 10, wherein said second client computing device client application allows QR Code customization of at least the following parameters:
a timeframe over which said QR Code is valid; and
an association to one or more correctional facilities.

12. The system for screening and secure distribution of privileged correspondence according to claim 6, further comprising a file locking mechanism invoked when privileged mail is sent electronically.

13. The system for screening and secure distribution of privileged correspondence according to claim 4, wherein said ASP server network maintains an audit trail of actions taken by said a first client computing device and said second client computing device.

14. A process for screening and secure distribution of privileged mail correspondence to incarcerated individuals, comprising the steps of:
an application service provider (ASP) providing a server computer with secure database management system including a database containing an inmate record of inmate identification data and inmate location data, and a privileged mail sender record of privileged mail sender identification data and authentication documents;
said application service provider (ASP) providing a remote prescreening application running on a remote computing device and comprising software instructions configured to enable privileged senders including attorneys, public officials, and educators to complete the substeps of,
pre-registering,
uploading authentication documents,
selecting to send a privileged mail piece through the U.S. postal service,
automatically generating a QR code and prompting said privileged mail sender to attach said QR code to said privileged mail piece, and
uploading an image of said privileged mail piece with QR Code attached;
said application service provider (ASP) providing a remote prescreening application running on a remote computing device and comprising software instructions configured to complete the substeps of
scanning the QR Code attached to the mail piece,
displaying the uploaded image of said privileged mail piece with QR Code attached for comparison and validation.

15. The process for screening and secure distribution of privileged mail correspondence to incarcerated individuals according to claim 14, wherein said step of uploading an image of said privileged mail piece with QR Code attached further comprises uploading an image of a sender holding an authentication document and said sender privileged mail piece with QR Code attached.

16. The process for screening and secure distribution of privileged mail correspondence to incarcerated individuals according to claim 14, wherein said step of automatically generating a QR code further comprises the substeps of,
generating a unique code for each mail piece that identifies the sender, receiver, correctional institution, and expiration, and
encrypting said unique code as a QR Code;
and said step of automatically generating said QR code includes printing said QR Code with unencrypted character string appearing beneath the QR Code that uniquely identifies an institution and inmate therein.
